(19) United States
(12) Patent Application Publication
(10) Pub. No.: US 2026/0051443 A1
(43) Pub. Date: Feb. 19, 2026

(54) METHOD FOR PRE-LITHIATING LITHIUM-ION CAPACITOR

(71) Applicants: Hyundai Motor Company, Seoul (KR); Kia Corporation, Seoul (KR)

(72) Inventors: Su Chan Lee, Hwaseong (KR); Seung Weon Son, Hwaseong (KR)

(21) Appl. No.: 19/090,024

(22) Filed: Mar. 25, 2025

(30) Foreign Application Priority Data
Aug. 19, 2024 (KR) 10-2024-0110817

(51) Int. Cl. H01G 11/86; H01G 11/06; H01G 11/28; H01G 11/32; H01G 11/50

(52) U.S. Cl. CPC H01G 11/86; H01G 11/28; H01G 11/32; H01G 11/50; H01G 11/06

(57) ABSTRACT

A technique for pre-lithiating a lithium-ion capacitor includes preparing multiple cathodes, anodes, and separators, stacking them, injecting electrolyte, and performing a multi-step charging process. Some anodes have surfaces coated with a lithium foil of 10-40 μm thickness, while others remain uncoated, and they alternate in the stack. Cathodes may include air pores occupying 0.001% to 50% of the collector area, while anodes have fewer or no pores. By using partially coated lithium foil strips and controlling pressing, temperature, and charging rates, lithium-ions move through the cathode to the uncoated anodes, reducing manufacturing costs and achieving efficient pre-lithiation. Post-treatment steps may discard or rework incompletely lithiated anodes. The approach provides a flexible way to optimize foil thickness, pore distribution, and charging profiles, enabling high-performance lithium-ion capacitors with improved cost and process efficiency.

### CROSS-REFERENCE TO RELATED APPLICATION

This application claims under 35 U.S.C. § 119 (a) the benefit of Korean Patent Application No. 10-2024-0110817, filed in the Korean Intellectual Property Office on Aug. 19, 2024, the entire contents of which are incorporated herein by reference.

### TECHNICAL FIELD

The present disclosure relates to a method for pre-lithiating a lithium-ion capacitor, capable of performing pre-lithiation in the state that an anode not coated with a lithium foil and an anode coated with a lithium foil are sequentially stacked in a structure including a cathode and an anode alternately stacked on each other, thereby reducing the use of a porous current collector such that the whole costs for the pre-lithiation is reduced.

### BACKGROUND

A lithium-ion capacitor has a capacity higher than a capacity of a conventional super-capacitor and power higher than a battery, through a technology of combining an anode of a lithium-ion battery and a cathode of a super-capacitor. Although the lithium-ion capacitor employs lithium-ions as carrier ions, which is similar to the lithium-ion battery, as the cathode and the anode include a carbon material, a lithium source is insufficient inside a cell. To overcome such disadvantages, the lithium-ion capacitor typically undergoes the pre-lithiation of charging lithium into the anode using an additional lithium source in advance. However, the conventional pre-lithiation for the lithium-ion capacitor has a limitation in various embodiments. Accordingly, there is required a process of pre-lithiating the lithium-ion capacitor more economically.

### SUMMARY

The present disclosure has been made to solve the above-mentioned problems occurring in the existing technologies while advantages achieved by the existing technologies are maintained intact. Some embodiments of the present disclosure provide a method for pre-lithiating a lithium-ion capacitor. More specifically, some embodiments of the present disclosure provide a method for pre-lithiating lithium-ion capacitor, in which a porous foil is employed as a current collector of a cathode, a general foil is employed as a current collector of an anode, an anode having a surface coated with a lithium foil and an anode having a surface not coated with the lithium foil are alternately used, and the lithium foil has at least 20 μm, thereby significantly reducing the costs for pre-lithiation.

The technical problems to be solved by the present disclosure are not limited to the aforementioned problems, and any other technical problems not mentioned herein will be clearly understood from the following description by those skilled in the art to which the present disclosure pertains.

To accomplish the above object, the present disclosure provides a method for pre-lithiating a lithium-ion capacitor and a lithium-ion capacitor.

In an aspect, a method for pre-lithiating lithium-ion capacitor is provided, the method comprising 1) forming a cell by alternately arranging cathodes and the anodes with separators interposed therebetween, wherein at least one anode is coated with a lithium foil, and at least one anode does not have lithium-foil coating on its surfaces; 2) adding an electrolyte composition to or into the cell; and thereafter 3) pre-lithiating the cell.

In additional aspects, (1) the present disclosure provides a method for pre-lithiating lithium-ion capacitor, which includes preparing a plurality of cathodes, a plurality of anodes, and a plurality of separators (S1), forming a cell by stacking the cathodes, the separators, and the anodes such that the separator is interposed between the cathode and the anode (S2), and performing the pre-lithiation after adding such as by injecting an electrolyte composition or solution into the cell (S3). The anode includes a first anode having opposite surfaces coated with the lithium foil, and a second anode having opposite surfaces not coated with the lithium foil, and the first anode and the second anode are alternately stacked on each other.
(2) The present disclosure provides a method for pre-lithiating lithium-ion capacitor, in which the cathode includes a cathode current collector, and a cathode active material layer formed on opposite surfaces of the cathode current collector, and the cathode current collector has air pores in (1).
(3) The present disclosure provides a method for pre-lithiating lithium-ion capacitor, in which a proportion of an area occupied by the air pores ranges from 0.001% to 50%, based on an entire area of the cathode current collector in (1) or (2).
(4) The present disclosure provides a method for pre-lithiating lithium-ion capacitor, in which the anode current collector includes air pores having an area occupied in proportion of at most 10% based on an entire area of the anode current collector or air pores are absent in the anode current collector in any one (1) to (3).
(5) The present disclosure provides a method for pre-lithiating lithium-ion capacitor, in which the lithium foil coated on the opposite surfaces of the first anode has a thickness ranging from 10 μm to 40 μm in any one (1) to (4).
(6) The present disclosure provides a method for pre-lithiating lithium-ion capacitor, in which the ‘S3’ is performed through an electrochemical pre-lithiation scheme, in any one (1) to (5).
(7) The present disclosure provides an lithium-ion capacitor including a plurality of cathodes, anodes, and separators interposed between the cathodes and the anodes, in which the anode includes a first anode having opposite surfaces coated with a lithium foil and a second anode having opposite surface not coated with the lithium foil, and the first anode and the second anode are alternately stacked on each other.
(8) The present disclosure provides an lithium-ion capacitor including a plurality of cathodes, anodes, and separators interposed between the cathodes and the anodes, in which the anode includes a third anode having lithium residues on a surface of the third anode, and a fourth anode having no lithium residues on a surface of the fourth anode, and the third anode and the fourth anode are alternately stacked on each other.

In some embodiments, a method for pre-lithiating a lithium-ion capacitor includes preparing multiple cathodes, anodes, and separators, then forming a cell by stacking these components so that each cathode and anode is separated by a separator, and finally performing pre-lithiation after injecting an electrolyte solution into the cell. The anode has a first anode with surfaces coated in lithium foil and a second anode with surfaces uncoated, arranged in alternating order. Additionally, the cathode may include a current collector with air pores, and the proportion of these pores may range from about 0.001% to about 50%. The anode may include a current collector with air pores occupying at most about 10% of its area, or no air pores at all. The lithium foil on the first anode may have a thickness from about 10 μm to about 40 μm. The pre-lithiation may be performed through an electrochemical scheme.

In some embodiments, a lithium-ion capacitor comprises a plurality of cathodes, anodes, and separators interposed between each cathode and anode. The anode has a first anode with surfaces coated in lithium foil and a second anode with surfaces uncoated, and these anodes are stacked in alternating order. Additionally, after a pre-lithiation process is complete, the first anode may become a third anode bearing lithium residues on its surface, while the second anode may become a fourth anode without such residues, with the third and fourth anodes also arranged in alternating sequence.

In some embodiments, a method for pre-lithiating a lithium-ion capacitor includes preparing multiple cathodes with air pores of about 0.001% to about 50% of their total area, anodes that are substantially pore-free or have at most about 10% pore area, and separators, then stacking these components so that at least one anode is partially coated with lithium foil strips and at least one anode remains uncoated. An electrolyte solution is injected, and a multi-step pre-lithiation is performed with at least two distinct charging stages, where the partially coated lithium foil may be about 10 μm to about 40 μm thick and transfers lithium-ions to the uncoated anode. Additionally, the foil strips may extend along the anode collector's length, and the pre-lithiation may include a lower-current stage followed by a stage that is at least 50% higher in current density. The partially coated foil may occupy less than about 70% of each coated surface and be at least about 20 μm thick to lower costs. A temperature of about 10° C. to about 40° C. may be maintained during the process, and each cathode may use a carbon-based active material. Each anode may use a carbon or silicon-containing material with a binder and conductive additive. The method may further include pressing the stack at about 5 MPa to about 20 MPa before electrolyte injection, and it may follow a constant-current-constant-voltage protocol until uncoated anodes reach about 90% of theoretical lithium uptake. The lithium foil strips may be formed by laser or die cutting and adhered under dry conditions, and any anode with incomplete lithiation-indicated by a voltage above about 0.3 V—may be removed or replaced.

### BRIEF DESCRIPTION OF THE DRAWINGS

The above and other objects, features and advantages of the present disclosure will be more apparent from the following detailed description taken in conjunction with the accompanying drawings:

FIG. 1 is a view schematically illustrating pre-lithiation in a cell-outer-portion concentration scheme;

FIG. 2 is a view schematically illustrating pre-lithiation in a lithium distribution scheme;

FIG. 3 is a view schematically illustrating pre-lithiation in an all-anode-surface-coating scheme;

FIG. 4 is a view schematically illustrating pre-lithiation according to the present disclosure; and

FIG. 5 is a view a comparison result between when a first anode and a second anode are alternately stacked on each other, and when the first anode and the second anode are not alternately stacked on each other.

### DETAILED DESCRIPTION

Hereinafter, the present disclosure will be described in more detail.

The terminology or words used in the present specification and the claims shall not be interpreted as commonly-used dictionary meanings, but should not be interpreted as to be relevant to the technical scope of the present disclosure based on the fact that the inventor may properly define the concept of the terms to explain the present disclosure in best ways.

The term “lithiate” used herein refers to the process of introducing lithium ions into an electrode material (e.g., an anode), typically by electrochemical means such as charging or doping, so that the electrode becomes lithiated and can intercalate or store lithium for subsequent battery operations.

The term “pre-lithiate” used herein refers to a specific form of lithiating an electrode (often an anode) before normal cell operation, ensuring that the electrode contains an adequate lithium reservoir at the outset. This process may involve an extra step within or outside the cell to supply lithium from an external source, thereby reducing issues like lithium deficiency during initial charging cycles.

The term “porous foil” used herein refers to a metallic foil, such as aluminum or nickel, that includes intentionally formed or naturally occurring pores or openings, allowing partial fluid or ion permeation through its structure.

The term “cell-outer-portion concentration scheme” used herein refers to a pre-lithiation approach in which a lithium source, for example a lithium foil, is positioned outside the cell stack, so that lithium ions migrate inward through porous current collectors to reach the anodes.

The term “lithium distribution scheme” used herein refers to a pre-lithiation approach in which multiple lithium sources are placed at different positions within the cell, enabling lithium ions to move in opposite or varied directions to charge the anode.

The term “all-anode-surface-coating scheme” used herein refers to a pre-lithiation strategy in which the surfaces of all anodes in the cell are directly coated with lithium, typically via a thin foil layer.

The term “electrochemical pre-lithiation” used herein refers to a process of charging and/or discharging the cell to drive lithium ions into an electrode (e.g., the anode), under controlled voltage or current conditions prior to normal battery operation.

The term “XPS analysis” used herein refers to X-ray Photoelectron Spectroscopy, an analytical technique used to detect the presence or absence of certain elements or chemical states, such as lithium residues, on the surface of an electrode.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

### Method for Pre-Lithiating Lithium-Ion Capacitor

Hereinafter, a method for pre-lithiating a lithium-ion capacitor according to the present disclosure will be described in detail.

The method for pre-lithiating the lithium-ion capacitor is largely classified into an in-situ scheme for performing a pre-lithiation process inside a cell and an ex-situ scheme for performing the pre-lithiation process in advance outside the cell and assembling the cell. The pre-lithiation in the in-situ scheme is classified into 1) a cell-outer-portion concentration scheme 2) a lithium distribution scheme, and 3) an all-anode-surface-coating scheme, depending on the positions of a lithium source positioned inside the cell.

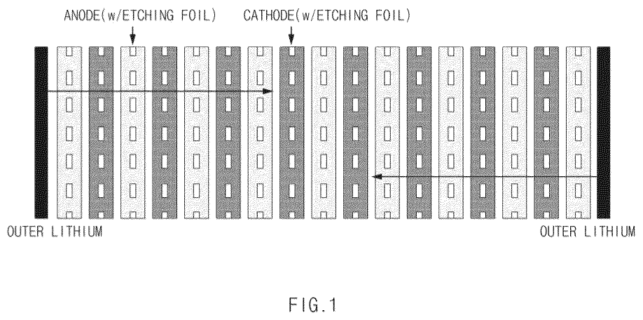

According to the cell-outer-portion concentration scheme, the cell is formed as illustrated in FIG. 1 to perform the pre-lithiation. As lithium-ions positioned at an outer portion of the cell are involved into the cell, the lithium-ions are charged into an anode inside the cell. However, to move the lithium-ions into the cell from the outer portion of the cell, current collectors of a cathode and the anode should be provided in the form of a porous foil having air pores. According to the present scheme, the thickness of the lithium foil, which is a lithium-ion source positioned at the outer portion of the cell, may range from about 80 μm to about 150 μm.

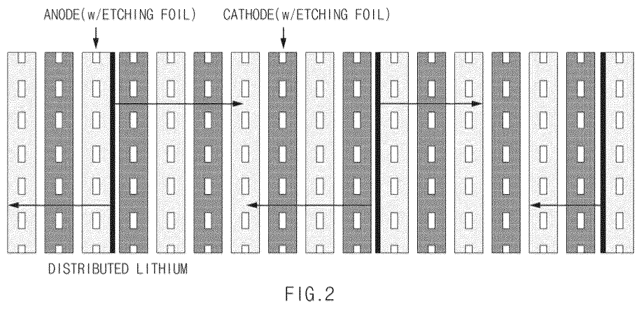

According to the lithium distribution scheme, the cell is formed as illustrated in FIG. 2 to perform the pre-lithiation. As lithium sources, which are positioned to be distributed inside the cell, move in opposite directions, lithium-ions may be charged into the anode inside the cell. Even in the present scheme, current collectors of a cathode and an anode should be provided in the form of a porous foil, which is similar to the cell-outer-portion concentration scheme. In this case, the thickness of the lithium foil distributed into the cell may range from about 40 μm to about 80 μm.

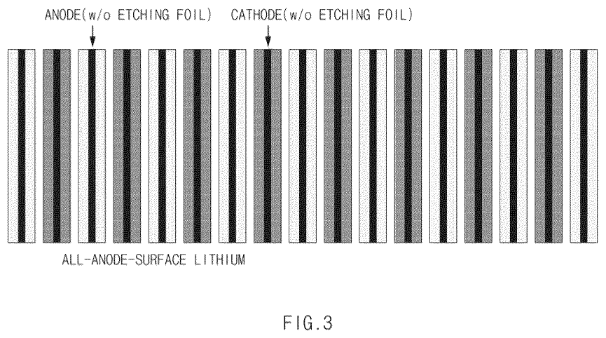

According to the all-anode-surface-coating scheme, the surfaces of all anodes are directly coated with lithium, as illustrated in FIG. 3. According to the present scheme, the current collectors of the cathode and the anode need not be porous. However, since the surfaces of all anodes are coated, the thickness of the lithium foil coated on the surface of the anode is in a significantly thin range from 5 μm to 15 μm.

Both of the cell-outer-portion concentration scheme and the lithium distribution scheme should use porous foils as current collectors. The porous foil has the manufacturing cost higher than the manufacturing cost of the general foil. In particular, since the anode of the cathode and the anode reacts with lithium, a higher penetration rate is required. Accordingly, the anode requires a porous foil having the higher penetration rate. The manufacturing cost for the porous foil is increased, as the penetration rate is increased. In particular, in the cell-outer-portion concentration scheme, to smoothly move the lithium-ions from the lithium foil, which is positioned at an outer portion of the cell, to the anode positioned in the inner most of the cell, the current collectors of the cathode and the anode should have the higher penetration rates, thereby largely increasing the manufacturing cost for the cell.

According to the all-anode-surface-coating scheme, although the general foil is able to be used instead of the porous foil, the thickness of the lithium foil should be significantly thin. The price of the lithium foil is varied depending on the thickness of the lithium foil. In general, the thin lithium foil of less than 20 μm is difficult to be manufactured, and thus is significantly high in the price of the lithium foil. Accordingly, according to the all-anode-surface-coating scheme, since the thin lithium foil is employed, the manufacturing costs for the cell are significantly increased. To employ a thicker lithium foil while employing the all-anode-surface-coating scheme, the lithium foil may be coated on the surfaces of all anodes. In this case, the lithium foil is coated to be divided in a strip form, such that the lithium foil has the thickness of at least a specific value. However, this scheme requires an additional process for manufacturing the lithium foil in the strip form. In addition, the coating of the lithium foil in the strip form requires a difficulty higher than a difficulty in the coating of a single lithium foil, thereby increasing a process difficulty. In addition, since the lithium-ions more slowly move in a horizontal direction with respect to an electrode, the time for the pre-lithiation is increased.

According to the method for pre-lithiating the lithium-ion capacitor of the present disclosure, to solve the above problems of the schemes, the effective pre-lithiation of the lithium-ion capacitor is possible at the least costs.

More specifically, the present disclosure provides the method for pre-lithiating the lithium-ion capacitor, which includes preparing a plurality of cathodes, a plurality of anodes, and a plurality of separators (S1), forming a cell by stacking the cathodes, the separators, and the anodes such that the separator is interposed between the cathode and the anode (S2), and injecting an electrolyte solution into the cell (S3). The anode includes a first anode having opposite surfaces coated with the lithium foil, and a second anode having opposite surfaces not coated with the lithium foil, and the first anode and the second anode are alternately stacked on each other.

According to the present disclosure, the lithium-ion capacitor includes a plurality of cathodes, a plurality of anodes, and a plurality of separators. Preparing the cathode, the anode, and the separator included in the lithium-ion capacitor may be first performed.

The cathode included in the lithium-ion capacitor may include a cathode current collector, and a cathode active material layer formed on opposite surfaces of the cathode current collector, and the cathode current collector may have air pores. According to the pre-lithiation of the present disclosure, the lithium foil should be only partially coated on the anode surface, and the cathode current collector should have air pores, because the lithium-ions of the lithium foil move to the anode at an opposite side, through the cathode in the pre-lithiation process.

The air pores of the cathode current collector may have a circular or amorphous shape, and the material of the cathode current collector may be a metal material, such as aluminum, stainless steel, nickel, or titanium, or a metal material alloy. In addition, a proportion of an area occupied by the air pores may range from 0.001% to 50%, based on the entire area of the cathode current collector. Preferably, the proportion of the area may be at least 0.1%, at least 0.5%, at least 1%, at least 3%, at least 5%, at least 10%, or at least 15%, and at most 50%, at most 45%, at most 40%, at most 35%, or at most 30%. When the cathode current collector satisfies the above-described conditions, lithium-ions may easily move from the lithium foil, and durability of the cathode may be ensured.

The cathode active material layer may include a conventional cathode active material employed in a lithium-ion capacitor, a binder, and a conductive material. For example, the cathode active material may be a carbon material, such as activated carbon, graphene, hard carbon or soft carbon, or a lithium metal oxide-based or sulfide-based active material. The oxide active material may be a rock salt type active material such as LiCoO₂, LiMnO₂, LiNiO₂, LiVO₂, or Li₁₊ₓNi_{1/3}Co_{1/3}Mn_{1/3}O₂, a spinel type active material such as LiMn₂O₄, or Li(Ni_{0.5}Mn_{1.5})O₄, a reverse spinel type active material such as LiNiVO₄, or LiCoVO₄, an olivine-type active material such as LiFcPO₄, LiMnPO₄, LiCoPO₄, or LiNPO₄, a silicon-containing active material such as Li₂FeSiO₄, or Li₂MnSiO₄, a rock salt type active material, such as LiNi_{0.8}Co_{(0.2-x)}AlₓO₂ (0<x<0.2), which is obtained by substituting a portion of the transition metal with a heterogeneous metal, a spinel-type active material, such as Li₁₊ₓMn_{2-x-y}MyO₄ (M is at least one of Al, Mg, Co, Fe, Ni, and Zn; <x+y<2), which is obtained by substituting a portion of the transition metal with a heterogeneous metal, or lithium titanate such as Li₄Ti₅O₁₂. The sulfide active material may be copper Chevrel, iron sulfide, cobalt sulfide, or nickel sulfide.

The binder, which is a component to bind ingredients contained in an electrode active material layer, may include butadiene rubber (BR), nitrile butadiene rubber (NBR), hydrogenated nitrile butadiene rubber (HNBR), polyvinylidene difluoride (PVDF), polytetrafluoroethylene (PTFE), or carboxymethylcellulose (CMC).

The conductive material, which enhances electron conductivity of the electrode active material layer, may be carbon black, conducting graphite, ethylene black, or graphene.

The anode included in the lithium-ion capacitor includes an anode current collector and anode active material layers formed opposite surfaces of the anode current collector. The anode current collector may include air pores having an area occupied in proportion of at most 10% based on the entire area of the anode current collector or may have no air pore. The anode employed in the method for pre-lithiating lithium-ion capacitor of the present disclosure includes a first anode having opposite surfaces coated with a lithium foil and a second anode having opposite surface not coated with the lithium foil, and the first anode and the second node are alternately stacked on each other. Accordingly, the lithium-ions are prevented from passing through the anode in the pre-lithiation procedure. Accordingly, the anode current collector may have air pores occupied in a significantly smaller area or may not have air pores. To reduce the time for the pre-lithiation process, the anode current collector having air pores may be employed. In this case, the proportion of the area occupied by the air pores may be at most 10%, preferably, at most 5%, based on the entire area of the anode current collector. As the proportion of the area occupied by the air pores of the anode current collector is increased, the manufacturing costs for the anode current collector are increased, and the durability of the anode current collector is degraded. However, according to the pre-lithiation scheme of the present disclosure, as the air pores in the anode current collector are minimized, the cost used in the pre-lithiation process may be minimized. Meanwhile, even the material of the anode current collector may be a metal material, such as aluminum, stainless steel, nickel, or titanium, or a metal material alloy, which is similar to the material of the cathode current collector.

Meanwhile, the thickness of the lithium foil coated on opposite sides of the first cathode above may range from 10 μm to 40 μm. Preferably, the thickness of the lithium foil may be at least 10 μm, at least 15 μm, and at most 40 μm, at most 35 μm, or at most 30 μm. According to the pre-lithiation in the conventional all-anode-surface-coating scheme, the lithium foil should have a thickness ranging from about 5 μm to 15 μm, which is a significantly thin thickness range. However, according to the present disclosure, as the lithium foil is partially coated on the anode, the thickness of the lithium foil may be more increased. Accordingly, the costs for reducing the thickness of the lithium foil may be saved. As the thickness of the lithium foil is decreased, the manufacturing cost is increased. Especially, a larger amount of costs are required to manufacture the lithium foil having the thickness of less than 20 μm. Accordingly, when the lithium foil has an appropriate thickness, the costs may be reduced. According to the present disclosure, the manufacturing costs for the lithium foil may be saved by partially coating the lithium foil on the anode.

The anode active material layer may include a conventional anode active material employed in the lithium-ion capacitor, a binder, and a conductive material. For example, the anode active material may be a carbon material, such as graphene, hard carbon or soft carbon, or a material such as a lithium metal oxide or silicon.

The description about the conductive material and the binder employed in the cathode active material layer may be identically applied to the description about the conductive material and the binder contained in the anode active material.

The separator may be a porous material through which lithium-ion may pass. The material of the separator is not specifically limited, as long as the material is employed for the separator in the technical field of the present disclosure. For example, the separator may include at least one selected from the group consisting of polyethylene and polypropylene, and ceramic or the binder may be coated on the separator including the material.

A cell structure may be formed by stacking the cathode, the anode, and the separator prepared as described above. More specifically, the lithium-ion capacitor according to the present disclosure has a plurality of structures by repeating, several times, a structure in which the separator is interposed between the cathode and the anode. More specifically, a cell structure may be formed by stacking a plurality of cathodes, a plurality anode, and a plurality separators prepared in order of a cathode, a separator, an anode, a separator, a cathode, a separator, and an anode.

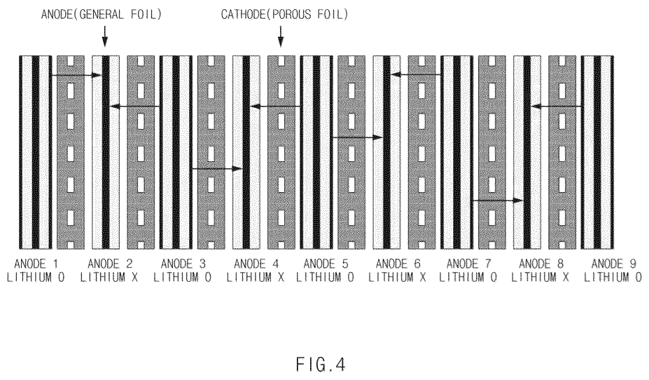

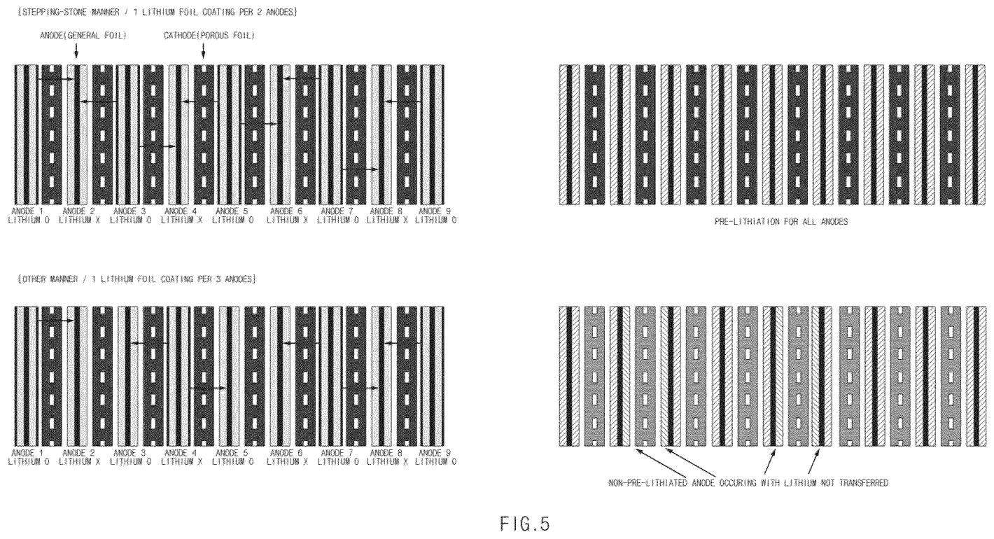

Meanwhile, when stacking the cathode, the anode, and the separator as described above, the anode should be disposed such that the first anode having opposite surfaced coated with a lithium foil and the second anode having opposite surfaces not coated with the lithium foil are alternately stacked on each other. For example, the first anode and the second anode should be arranged in order of a cathode, a separator, a first anode, a separator, a cathode, a separator, a second anode, and a separator. As described above, when the first anode and the second anode are alternately stacked on each other, as illustrated in FIGS. 4 and 5, lithium-ions, which are formed from the lithium foil coated on the opposite surfaces of the first anode, may pass through the facing the cathode, and move the second anode not coated with the lithium foil. Accordingly, the pre-lithiation may be performed with respect to all anodes. When the first anode and the second anode are not alternately stacked on each other as described above, an anode, which is failed to contact with the lithium-ions and to undergo the pre-lithiation, may be present. More specifically, as illustrated in FIG. 5, when the first anode and the second anode are not alternately stacked, but stacked on each other in order of the first anode, the second anode, and the second anode, as the lithium-ions are not transferred, the anode, which is failed to undergo the pre-lithiation, may be present.

The electrolyte solution may be injected into the cell and the pre-lithiation may be performed, after forming the lithium-ion capacitor structure as described above. When the electrolyte solution is injected into the cell, the lithium metal, which is contained in the lithium foil coated on the surface of the first anode, may be changed to the lithium-ions through the pre-lithiation, pass through the separator and the cathode, and then move into the second anode.

The pre-lithiation may be performed through an electrochemical scheme. The electrochemical scheme is to pre-lithiate the surface of the anode by applying a current or a voltage to the lithium-ion capacitor to charge and/or discharge the lithium-ion capacitor. The charging and/or discharging conditions may be varied depending on the desirable degree of pre-lithiation.

The electrolyte solution is not particularly limited, as long as the electrolyte solution is used in the lithium-ion capacitor. For example, the electrolyte solution may include a lithium salt. The lithium salt may be at least one selected from the group consisting of LiPF₆, LiBF₄, LiClO₄, LiSbF₆, LiAsF6, LiN(SO₂C₂F₅)₂, LiN(CF₃SO₂)₂, LiN(SO₃C₂F₅)₂, LiN(SO₂F)₂, LiCF₃SO₃, LiCAF₉SO₃, LiC₆H₅SO₃, LiSCN, LiAlO₂, LiAlC₄, LiN(CxF₂ₓ₊₁SO₂) (CyF_{2y+1}SO₂), LiCl, LiI and LiB (C₂O₄)₂. In addition, a solvent of the electrolyte solution may be a non-aqueous organic solvent and may be at least one selected from the group consisting of carbonate, ester, ether, and ketone. Especially preferably, the solvent of the electrolyte solution may be a cyclic carbonate-based solvent or a linear carbonate-based solvent. The cyclic carbonate may be at least one selected from the group consisting of ethylene carbonate, propylene carbonate, butylene carbonate, vinylene carbonate, vinylethylene carbonate, and fluoroethylene carbonate, and the linear carbonate may be at least one selected from the group consisting of dimethyl carbonate, diethyl carbonate, dipropyl carbonate, ethylmethyl carbonate, methyl propyl carbonate, methyl isopropyl carbonate, and ethyl propyl carbonate. The electrolyte may include an electrolyte additive, and the electrolyte additive may include vinylene carbonate, or vinyl ethylene carbonate. As the electrolyte solution is injected, the pre-lithiation process may be more efficiently performed.

### Lithium-Ion Capacitor

The present disclosure provides a lithium-ion capacitor for applying the method for pre-lithiating the lithium-ion capacitor described above.

More specifically, the present disclosure provides a lithium-ion capacitor having a structure including a plurality of cathodes, anodes, and separators interposed between the cathodes and the anodes, the anode includes the first anode having opposite surfaces coated with a lithium foil and the second anode having opposite surface not coated with the lithium foil, and the first anode and the second node are alternately stacked on each other.

The lithium-ion capacitor, which is a lithium-ion capacitor before the pre-lithiation is performed, has a structure in which the first anode having opposite surfaces coated with the lithium foil and the second anode having opposite surface not coated with the lithium foil are alternately stacked on each other, as described above.

In addition, the present disclosure provides a lithium-ion capacitor has a structure including a plurality of cathodes, anodes, and separators interposed between the cathodes and the anodes, the anode includes a third anode having lithium residues on the surface thereof, and a fourth anode having no lithium residues on the surface thereof, and the third anode and the fourth anode are alternately stacked on each other.

The third anode is the first anode after the pre-lithiation process for the lithium-ion capacitor described above, and the fourth anode is the second anode after the pre-lithiation process. In the first anode directly contacting with the lithium, fine lithium residues are present on the anode surface even after the pre-lithiation process. On the contrary, in the second anode, which directly does not contact with the lithium, the lithium residues are absent on the surface of the second anode.

Accordingly, the lithium-ion capacitor having undergone the method for pre-lithiating the lithium-ion capacitor of the present disclosure has the third anode and the fourth anode. Meanwhile, the presence of the lithium residues may be recognized through an XPS analysis.

When employing the method for pre-lithiating the lithium-ion capacitor according to the present disclosure, the porous foil is used only for the cathode, and the lithium foil employed as the lithium source has a thickness of at least a specific value, thereby minimizing the costs for the use of the porous foil and the costs for reducing the thickness of the lithium foil, such that pre-lithiation is sufficiently performed at lower costs.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for pre-lithiating a lithium-ion capacitor, the method comprising:
forming a cell comprising alternately arranging cathodes and the anodes with the separators interposed therebetween, wherein at least one anode is coated with a lithium foil, and at least one anode does not have lithium-foil coating on its surfaces;
adding an electrolyte composition into the cell; and thereafter
pre-lithiating the cell.

2. The method of claim 1, wherein the cathode includes:
a cathode current collector and cathode active material layers formed on opposite surfaces of the cathode current collector, and
wherein the cathode current collector has air pores.

3. The method of claim 2, wherein a proportion of an area occupied by the air pores ranges about from 0.001% to 50%, based on an entire area of the cathode current collector.

4. The method of claim 1, wherein the anode includes:
an anode current collector and an anode active material layers formed on opposite surfaces of the anode current collector, and
wherein the anode current collector includes air pores having an area occupied in proportion of at most 10%, based on an entire area of the anode current collector or air pores are absent in the anode current collector.

5. The method of claim 1, where the lithium foil coated on the opposite surfaces of a first anode has a thickness ranging about from 10 μm to 40 μm.

6. The method of claim 1, wherein the pre-lithiating is performed through an electrochemical pre-lithiation scheme.

7. A lithium-ion capacitor comprising:
a plurality of cathodes, anodes, and separators interposed between the cathodes and the anodes,
wherein the anode includes:
a first anode having opposite surfaces coated with a lithium foil and a second anode having opposite surface not coated with the lithium foil, and
wherein the first anode and the second anode are alternately stacked on each other.

8. The lithium-ion capacitor of claim 7, wherein, after a pre-lithiation process is performed, the first anode corresponds to a third anode having lithium residues on a surface thereof, and the second anode corresponds to a fourth anode having no lithium residues on a surface thereof, and the third anode and the fourth anode are alternately stacked on each other.

9. A method for pre-lithiating a lithium-ion capacitor, the method comprising:
preparing a plurality of cathodes, a plurality of anodes, and a plurality of separators, each cathode having a cathode current collector that includes air pores in a proportion ranging from about 0.001% to about 50% of an entire cathode current collector area, and each anode having an anode current collector that is substantially free of air pores or has air pores occupying at most about 10% of an entire anode current collector area;
forming a stack by alternately arranging the cathodes and the anodes with the separators interposed therebetween, such that at least one anode is partially coated with a lithium foil in a strip pattern, and at least one anode is free of lithium-foil coating on its surfaces;
adding an electrolyte composition into the stack; and
performing a multi-step pre-lithiation by applying different charging conditions in at least two sequential stages, wherein the partially coated lithium foil on the at least one anode has a thickness of about 10 μm to about 40 μm and is configured to transfer lithium-ions to an adjacent uncoated anode through the cathode.

10. The method of claim 9, wherein the strip pattern of the lithium foil comprises two or more spaced-apart foil strips arranged across each coated anode surface, with each strip extending substantially along a lengthwise direction of the anode current collector.

11. The method of claim 9, wherein the multi-step pre-lithiation includes:
a first charging stage at a current density of about 0.05 C to about 0.1 C; and
a second charging stage at a current density higher than the first charging stage by at least about 50%.

12. The method of claim 9, wherein the partially coated lithium foil occupies less than about 70% of each coated anode surface area to allow lithium-ions to move laterally through the cathode during the pre-lithiation process.

13. The method of claim 9, wherein the thickness of the partially coated lithium foil is at least about 20 μm, thereby reducing fabrication costs relative to a fully coated lithium foil having a thickness of about 5 μm to about 15 μm.

14. The method of claim 9, further comprising controlling a temperature of the stack in a range from about 10° C. to about 40° C. during the multi-step pre-lithiation, so as to improve lithium-ion diffusivity and reduce process time.

15. The method of claim 9, wherein each cathode comprises a carbon-based active material selected from the group consisting of activated carbon, graphene, hard carbon, soft carbon, or combinations thereof.

16. The method of claim 9, wherein each anode comprises a carbon-based active material or a silicon-containing material, and further includes a binder and a conductive additive dispersed therein.

17. The method of claim 9, further comprising pressing the stack under a pressure ranging from about 5 MPa to about 20 MPa prior to injecting the electrolyte solution, thereby enhancing interface contact between the partially coated anodes and adjacent components.

18. The method of claim 9, wherein the multi-step pre-lithiation is performed via a constant-current constant-voltage (CC-CV) protocol that terminates when each uncoated anode reaches at least about 90% of a theoretical lithium uptake.

19. The method of claim 9, wherein the partial lithium foil strips on each coated anode are formed by laser cutting or die cutting from a bulk lithium foil, and subsequently adhered to the anode current collector under a dry-room environment.

20. The method of claim 9, further comprising removing or replacing any anode that exhibits incomplete lithiation, as indicated by a residual voltage exceeding about 0.3 V versus a lithium reference electrode after the multi-step pre-lithiation is complete.
